(19) United States
(12) Patent Application Publication
(10) Pub. No.: US 2011/0065420 A1
(43) Pub. Date: Mar. 17, 2011

(54) METHOD AND SYSTEM FOR BINDING PAYMENT METHODS AND PAYMENT INFORMATION TO MOBILE DEVICES

(76) Inventor: Randy de los Reyes, Issaquah, WA (US)

(21) Appl. No.: 12/881,107

(22) Filed: Sep. 13, 2010

Related U.S. Application Data
(60) Provisional application No. 61/241,926, filed on Sep. 13, 2009.

(51) Int. Cl. H04M 11/00; H04M 1/66

(52) U.S. Cl. 455/411

(57) ABSTRACT

Embodiments of the present invention provide distributed-data-structure-implemented licenses, shared between purchasers and an authentication service, that, in one embodiment of the present invention, are partially stored on purchasers' devices and partially stored within an authentication-service database to facilitate payment authorization, purchase tracking, and other methods and operations within an e-commerce environment. When the authentication service finds previously-installed licenses on a purchaser's device, the authentication service can automatically reconstruct and verify device-authentication information and payment information, so that a purchaser need not re-enter the reconstructed information, through awkward text-input facilities of a mobile device, to multiple displayed forms. The authorization protocols and distributed-data-structure-implemented licenses provide increased security for electronic commerce via mobile devices.

### CROSS-REFERENCE TO RELATED APPLICATION

This application claims the benefit of Provisional Application No. 61/241,926, filed Sep. 13, 2009.

### TECHNICAL FIELD

The present invention is related to electronic commerce and, in particular, to an authentication-service-implemented method for binding payment methods and information to mobile devices.

### SUMMARY

Embodiments of the present invention provide distributed-data-structure-implemented licenses, shared between purchasers and an authentication service, that, in one embodiment of the present invention, are partially stored on purchasers' devices and partially stored within an authentication-service database to facilitate payment authorization, purchase tracking, and other methods and operations within an e-commerce environment. When the authentication service finds previously-installed licenses on a purchaser's device, the authentication service can automatically reconstruct and verify device-authentication information and payment information, so that a purchaser need not re-enter the reconstructed information, through awkward text-input facilities of a mobile device, to multiple displayed forms. The authorization protocols and distributed-data-structure-implemented licenses provide increased security for electronic commerce via mobile devices.

### BRIEF DESCRIPTION OF THE DRAWINGS

FIG. 1 illustrates a cell phone and cellular radio tower.

FIG. 2 illustrates partitioning of a geographical region into cells.

FIG. 3 illustrates certain of the components of a 3G telecommunications network.

FIGS. 4A-B provide high-level block diagrams for certain of the internal components of a cell phone.

FIG. 5 provides a high-level block diagram of the software architecture for a cellular telephone.

FIG. 6 illustrates the software architecture for the operating system and higher-level software that runs on the application processor of an example cell phone.

FIG. 7 illustrates a general-purpose computer system that, when executing a software-implemented authentication-service program, represents an example embodiment of the present invention, comprises a system embodiment of the present invention.

FIGS. 8-10D show an example mobile-device e-commerce environment that illustrates deficiencies of currently-available e-commerce systems.

FIG. 11 illustrates one approach to simplifying the e-commerce environment in which mobile-phone users purchase items through e-commerce web pages according to certain embodiments of the present invention.

FIG. 12 illustrates an authorization system and protocol that provides identifying and payment information to transaction-processing system in order to streamline e-commerce for mobile-device purchasers, according to one embodiment of the present invention.

FIG. 13 shows four different types of distributed data structures, or licenses, that may be a shared between a purchaser's device and an authentication service according to one embodiment of the present invention.

FIGS. 14A-E illustrate, in control-flow-like diagrams, an authentication-service protocol that represents one embodiment of the present invention.

FIG. 15 provides a control-flow diagram for a device-identification routine used by the authentication service to identify and authenticate a purchaser's device, according to one embodiment of the present invention.

FIGS. 16A-B illustrate an authentication-service architecture and corresponding client-side architecture for devices that are authenticated by the authentication service, according to one embodiment of the present invention.

FIGS. 17A-B provide a representative example of routines included in each of the subcomponents of an authentication service that represents one embodiment of the present invention.

### DETAILED DESCRIPTION

Embodiments of the present invention are described, below, in two subsections. The first subsection provides an overview of mobile devices, cell-phone networks, and computer systems. In a second subsection, embodiments of the present invention are disclosed.

### Technology Overview

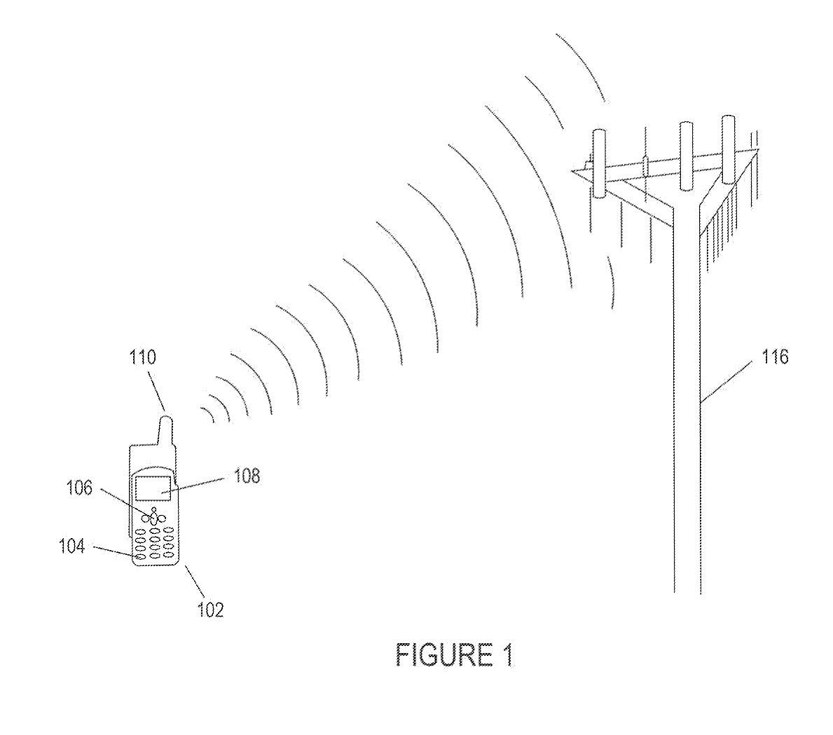

FIG. 1 illustrates a cell phone and cellular radio tower. The cell phone 102 is generally a compact, hand-held device that includes alphanumeric-character input keys, such as key 104, for input of numeric and text-character data, various control keys 106, for navigation through user-interface displays and menus, an LCD display 108, and a radio-frequency antenna 110. The cell phone broadcasts radio-frequency signals to, and receives radio-frequency signals from, one or more local cellular radio towers 116. The radio-frequency signals are multiplexed by frequency-division-multiple-access (“FDMA”) or code-division-multiple-access (“CDMA”) multiplexing to allow many cell telephones to broadcast and receive signals from multiple cellular radio towers within a local geographical area.

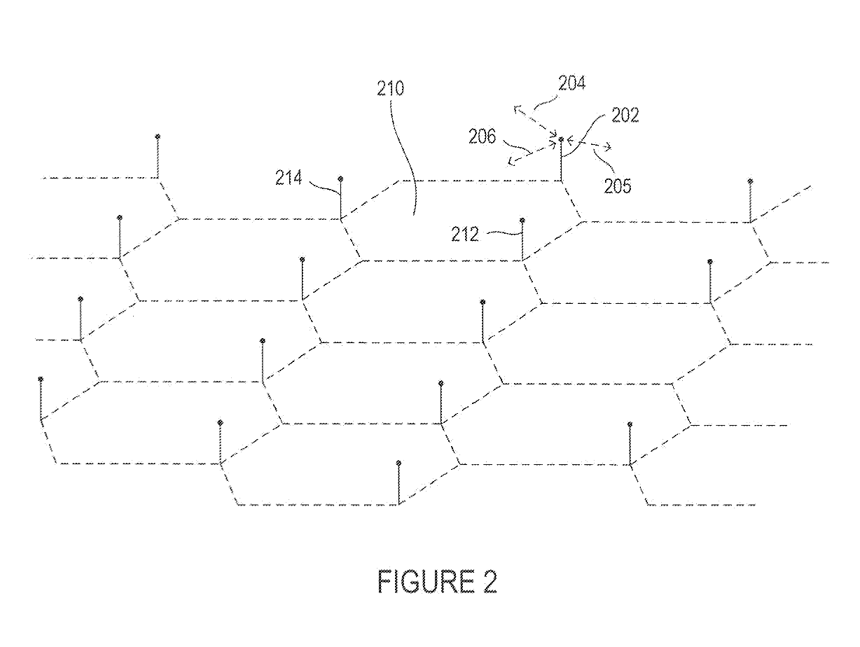

The word “cell” in the phrase “cell phone” and the word “cellular” in the phrases “cellular network” and “cellular radio tower” refers to the partitioning of a geographical region into generally hexagonally-shaped sub-regions, referred to as “cells,” by the locations and directional broadcast characteristics of a number of cellular radio towers. FIG. 2 illustrates partitioning of a geographical region into cells. In FIG. 2, a large number of cellular radio towers are depicted as vertical line segments capped with a small disk, such as vertical line segment 202. Each cellular radio tower generally includes a three-sided, or triangular, antenna mount that allows for broadcast and reception or radio signals roughly aligned with three directional, co-planar axes separated from one another by 120°, such as the three axes 204-206 shown for cellular radio tower 202. The geographical region is subdivided into hexagonal cells, indicated in FIG. 2 by dashed lines. Hexagonal cell 210 is served by cellular radio towers 202, 212, and 214, each with a directional broadcast axis directed towards the center of the cell. A cell-telephone user may walk or drive from one cell to another, and the network of cellular radio towers, associated base stations connected to a complex telecommunications network, allows the telecommunications network to transfer the mobile-electronic device, in real time, from broadcasting and receiving signals from the cellular radio towers associated with one cell to those associated with another, without interruption in an on-going phone call or electronic data-exchange operation.

There are a variety of different types of mobile telecommunications systems. One common mobile telecommunications system is referred to as the “universal mobile telecommunication system” (“UMTS”), one of several third-generation (“3G”) mobile telecommunications technologies. The UMTS system supports data transfer rates up to 21 Mbit/second, although, with current handsets, maximum data-transfer rates generally do not exceed 7.2 Mbit/second. UMTS systems provide for cells of varying sizes, depending on population density, presence of buildings and other obstacles, and other considerations. In rural areas, cellular telephone towers may be separated by distances greater than 30 miles, while, in certain urban environments, a cell may span a single floor of a building. Fourth-generation (“4G”) mobile telecommunications systems are already deployed, which feature improved data-transfer rates, increased communications security, and support for IP telephony, ultra-broadband Internet access, gaming services, and streamed multimedia. The 4G systems are intended to provide data-transfer rates of up to 1 Gbit/s via an all-IP packet-switched network architecture.

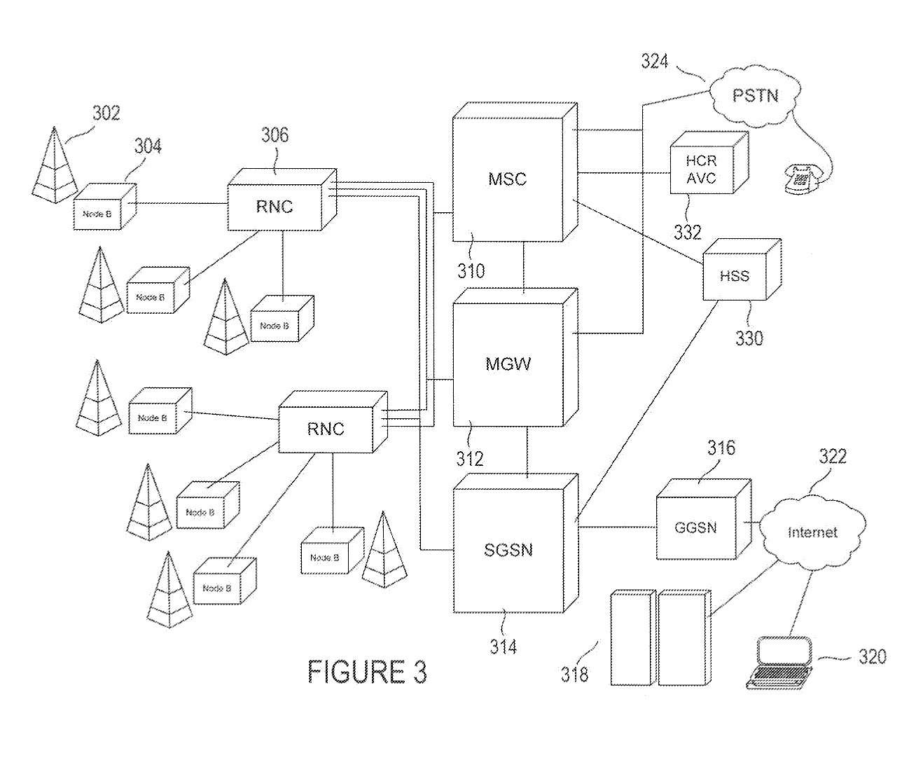

FIG. 3 illustrates certain of the components of a 3G telecommunications network. In FIG. 3, cellular telephone towers and other antennas are indicated by antenna-like symbols, such as antenna-like symbol 302. Each cellular radio tower, or other antenna, is associated with a Node B base station, such as Node B base station 304 with which antenna 302 is associated. A single Node B base station may be associated with multiple antennas or cellular radio towers. The base stations include power amplifiers, digital-signal processors, and back-up batteries, and are generally responsible for broadcasting signals received by the base station from the cellular network to cell phones within the geographical area serviced by the base station and for forwarding signals received from cell phones to the cellular network. Base stations are directly connected to radio network controllers (“RNC”), such as RNC 306 in FIG. 3. Each RNC may be connected to multiple base stations. The RNCs are, in turn, connected to various components of the core cellular network, including a mobile switching center (“MSC”) 310, a media gateway (“MGW”) 312, and a serving GPRS support node (“SGSN”) 314, the acronym “GPRS” standing for “general packet radio service.” The SGSN 314 interconnects RNCs, via gateway GPRS support nodes (“GGSN”) 316, to remote computing systems 318 and 320 via the Internet 322. The MSC 310 interconnects RNCs with a public switched telecommunications network (“PSTN”) 324. The MGW 312 is concerned with data transfer in both circuit-based switch networks, such as PSTN, as well as in packet-based switch networks, such as the Internet, and is controlled by SGSNs and MSCs. Many additional components are included in the core telecommunications network, including a home-subscriber-server facility 330, home-location-register and authentication center 332, and many additional components and nodes not shown in FIG. 3.

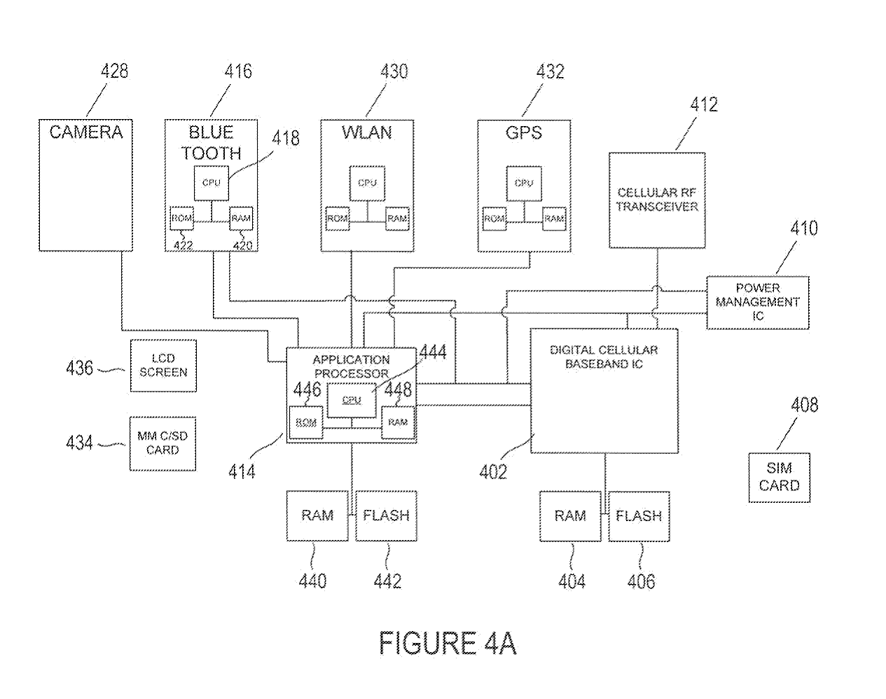

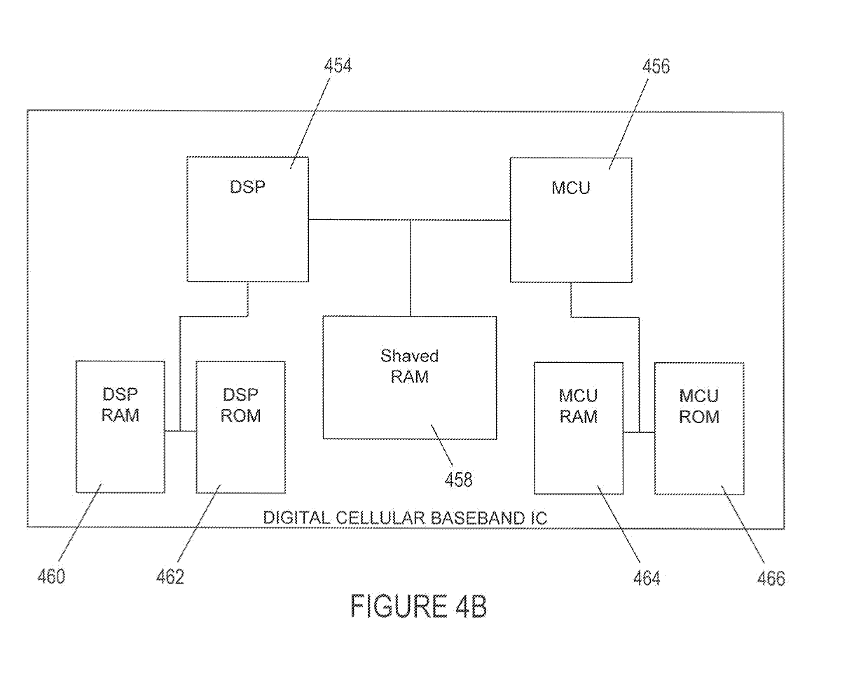

FIGS. 4A-B provide high-level block diagrams for certain of the internal components of a cell phone. Referring first to FIG. 4A, these components include a dual-core digital cellular baseband integrated circuit 402, which converts analog radio signals to digital signals and digital signals to analog signals, manages communications-protocol layers, and runs certain cell telephone applications, including applications responsible for initiation of phone-calls and maintenance of a locally-stored phone book, and a portion of the cell-phone user interface. The digital cellular baseband integrated circuit is interconnected with external RAM 404 and flash 406 memory, a subscriber identity module (“SIM”), or SIM card, 408, a power-management integrated circuit 410, a cellular radio-frequency (“RF”) transceiver 412, a separate application processor integrated circuit 414, and a Bluetooth module 416 that includes a processor 418 and both RAM 420 and ROM memory 422. The application processor 414 provides the computational bandwidth to a variety of non-radio-communications applications, including digital-camera-based applications, Internet browser, games, networking, and GPS-related functions. An application processor may be connected to a video camera 428, a WLAN module 430, a GPS module 432, an MMC/SD card 434, and an LCD screen 436. The application processor is additionally interconnected with external RAM 440 and flash 442 memory, and includes a processor 444 and internal ROM 446 and RAM 448 memory.

FIG. 4B shows a high-level block diagram for the digital cellular baseband integrated circuit (402 in FIG. 4). The digital cellular baseband integrated circuit includes a digital signal processor (“DSP”) 454, a microcontroller 456, shared internal RAM 458, and DSP-associated RAM 460 and ROM 462 as well as microcontroller-associated RAM 464 and ROM 466.

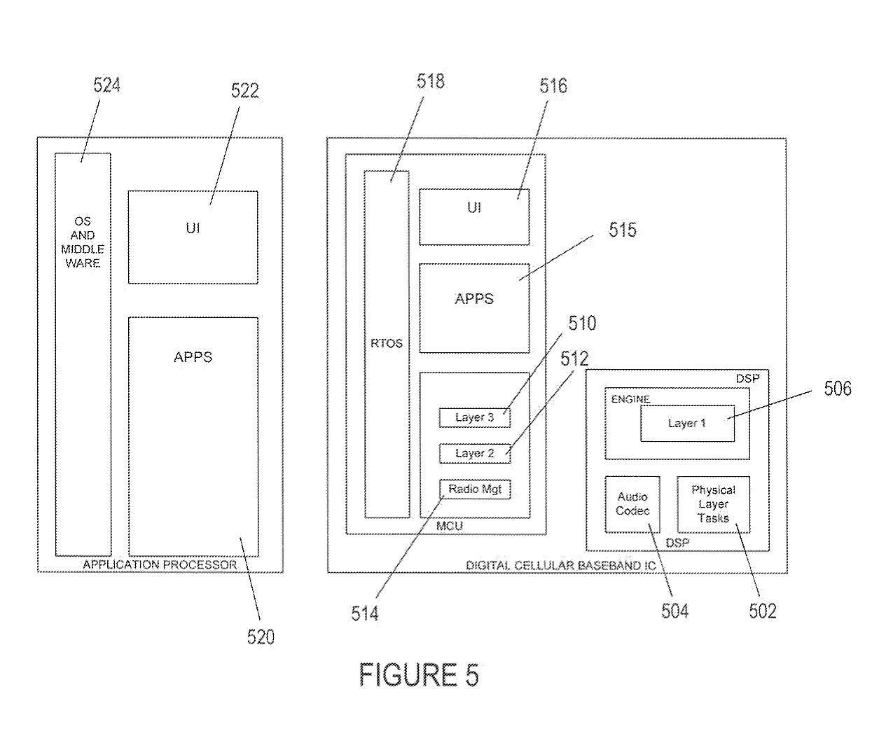

FIG. 5 provides a high-level block diagram of the software architecture for a cellular telephone. The DSP (454 in FIG. 4B) is responsible for the physical layer of the protocol stack associated with RF broadcast and reception 502, provides an audio codec 504, and carries out tasks associated with the first layer of a three-layer communications-protocol stack 506. The microcontroller (456 in FIG. 4B) executes software that implements the upper two layers of the three-layer protocol stack 510 and 512, various radio-management functions 514, and executes certain applications 514 and user-interface routines 516 layered above a real-time operating system 518. For example, the microcontroller may store and manage a local phone book and provide a user-interface (“UI”) for initiating and answering phone calls, via a phone application the executes on the microcontroller. The application processor (414 in FIG. 4) runs numerous software applications 520 and UI routines 522 above an operating system and a middle-ware layer 524.

A cell phone thus generally contains, at a minimum, three processors, including an application processor, microcontroller, and DSP, and often as many as six or more processors, including processors within separate Bluetooth, GPS, and WLAN modules. The cell phone includes various different electronic memories, some integrated with the processors and others external to the processors and interconnected with the processors via memory busses.

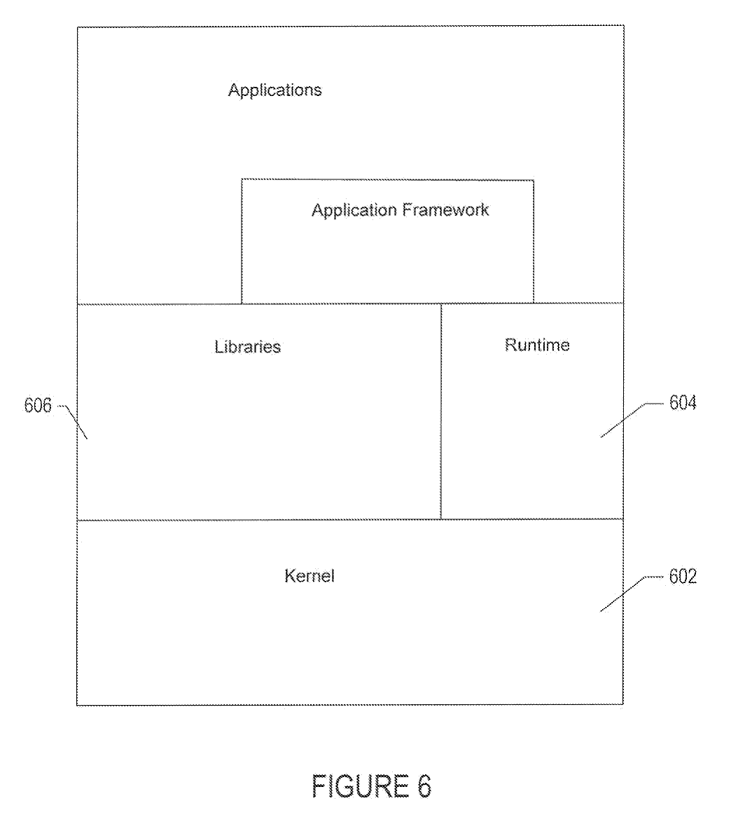

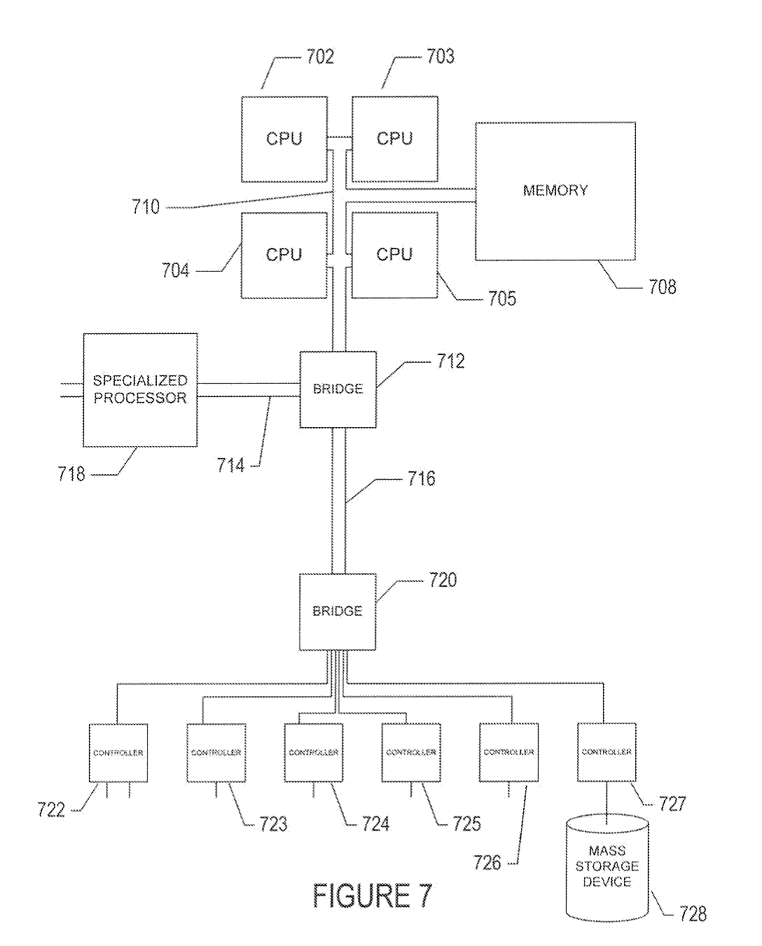

FIG. 6 illustrates the software architecture for the operating system (“OS”) and higher-level software (520, 522, and 524 in FIG. 5) that runs on the application processor of an example cell phone. At the lowest level, an OS kernel 602, such as the Linux kernel, provides drivers and various low-level support facilities at the machine interface. A runtime component 604 includes core libraries and a virtual machine that provide an execution environment for higher-level routines and programs. An extensive set of libraries 606 interface to the runtime component and kernel to provide a wide variety of routines and facilities for application programs. These libraries include standard system libraries, media libraries, graphics routines, a web-browser engine, a relational database engine, and other such libraries and facilities. An application-framework component 608 provides high-level functionality to support application programs 610; the highest level of software in the system. This functionality includes routines for accessing and controlling basic display components, hardware features, generating and managing execution threads, timers and alarms, and many additional facilities needed by application programs.

Cell telephones are generally low-power devices that run on energy stored in batteries or battery packs. While, initially, cell telephones were generally small, lightweight, and compact, and lacked both the power and air-cooled volume to drive and cool relatively high-power components such as those normally found in desktop and laptop computers, continued efforts to increase feature densities of integrated circuits and increase the functionality of electronic components while decreasing cost, size, and power consumption have led to rapidly increasing computational capacities of modern cell phones. However, display size and input-entry functionality of cell phones and other mobile devices continues to constrain cell-phone functionality and usability. Often, cell phones feature either miniature keyboards or touch-screen keyboards that are difficult to manipulate, resulting in very low data-transfer rates through the mobile-device-input facilities. Furthermore, particularly when a mobile-cell-phone user is moving relative to stationary mobile-phone-system transceivers, connections may be disrupted, requiring users to reconnect and re-enter data entered prior to the last disconnection. Slow data input and frequent disconnections frustrate interactions between mobile-phone users and interactive web pages, including e-commerce web pages.

FIG. 7 illustrates a general-purpose computer system that, when executing a software-implemented authentication-service program, represents an example embodiment of the present invention, comprises a system embodiment of the present invention. The computer system contains one or multiple central processing units (“CPUs”) 702-705, one or more electronic memories 708 interconnected with the CPUs by a CPU/memory-subsystem bus 710 or multiple busses, a first bridge 712 that interconnects the CPU/memory-subsystem bus 710 with additional busses 714 and 716, or other types of high-speed interconnection media, including multiple, high-speed serial interconnects. These busses or serial interconnections, in turn, connect the CPUs and memory with specialized processors, such as a graphics processor 718, and with one or more additional bridges 720, which are interconnected with high-speed serial links or with multiple controllers 722-727, such as controller 727, that provide access to various different types of mass-storage devices 728, electronic displays, input devices, and other such components, subcomponents, and computational resources. Software instructions that implement an authentication-service embodiment of the present invention may be encoded and stored on any of various computer-readable media, including magnetic and optical disks and electronic memories. Embodiments of the present invention may also be implemented on distributed computer systems and can also be implemented partially in hardware logic circuitry. Method embodiments of the present invention are necessarily implemented for execution by computer systems and other electronic computing systems, since the method embodiments involve large numbers of complex logic and arithmetic operations that need to be carried out reliably at rates sufficient to process authorization requests concurrently generated by many purchaser devices.

### Embodiments of the Present Invention

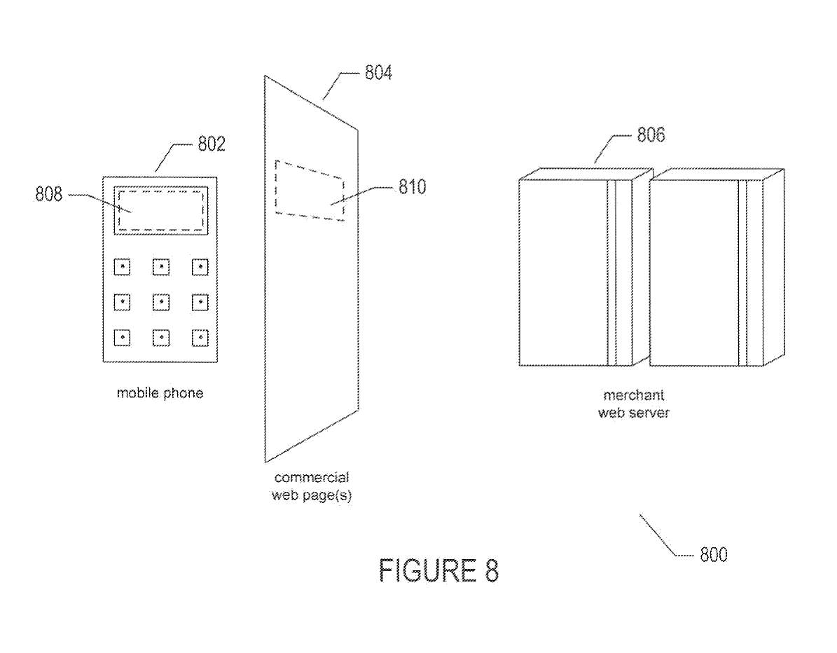

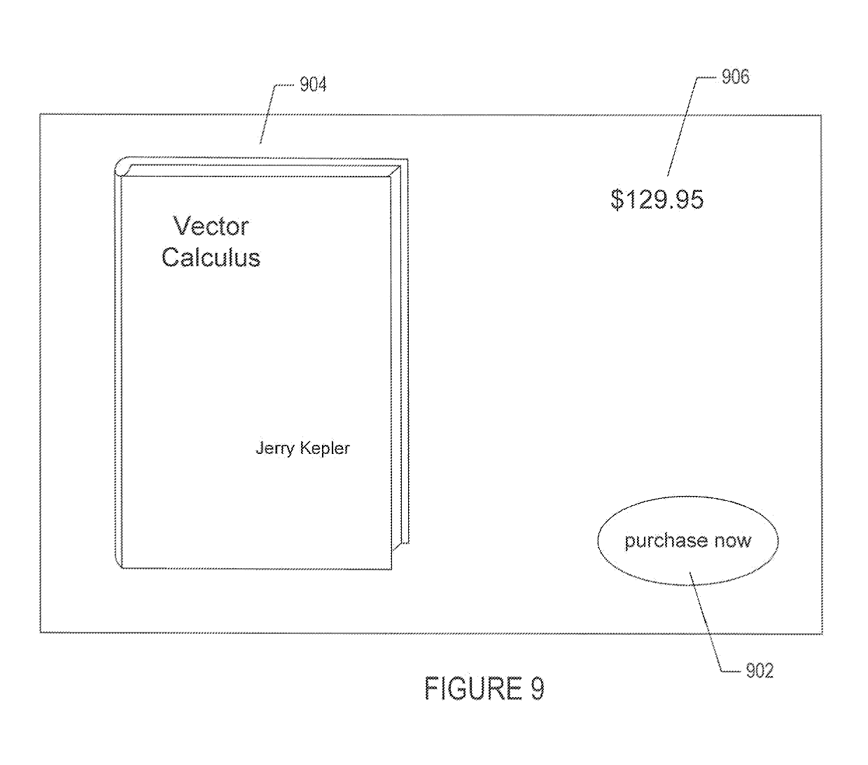

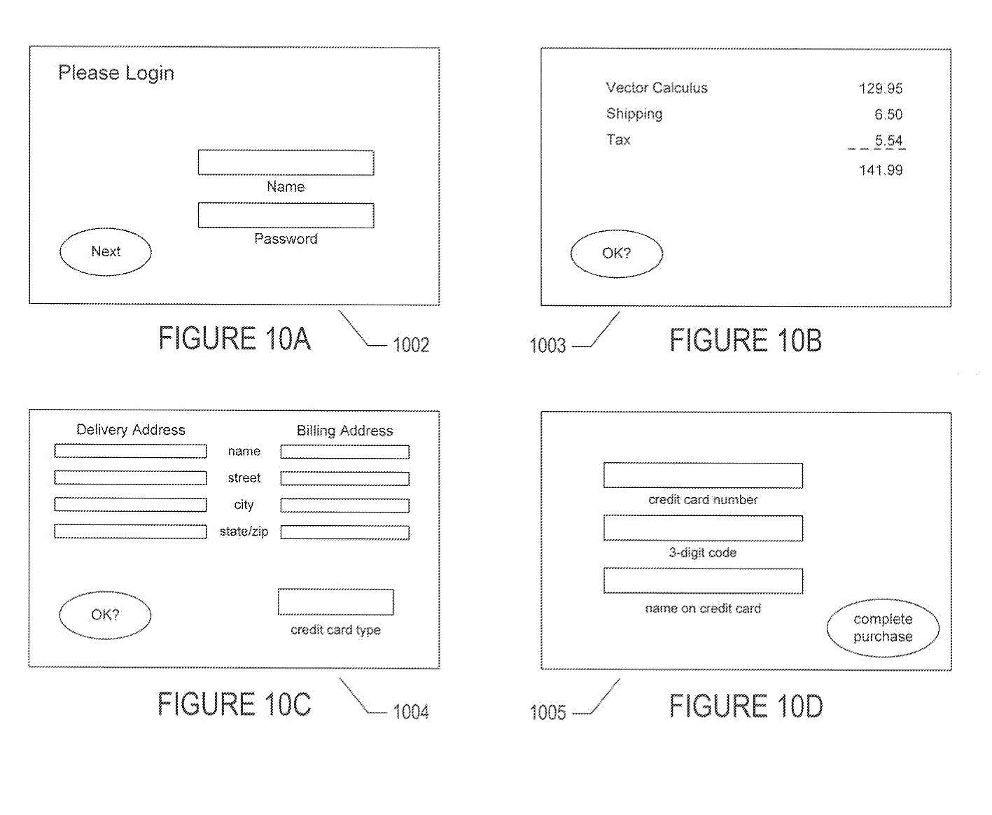

FIGS. 8-10D show an example mobile-device e-commerce environment that illustrates deficiencies of currently-available e-commerce systems. In this e-commerce environment 800, a mobile-phone user accesses, using a mobile phone 802, an e-commerce web page 804 provided by a merchant web server 806. In certain cases, the small display 808 size of a mobile phone allows for only a portion 810 of the web page 804 to displayed by the mobile phone, with the mobile-phone user needing to move a viewing window about the web page in order to view the contents of the web page. Modern web servers can, alternatively, determine the type of accessing device, and serve web pages designed to be more easily viewed on a mobile device. FIG. 9 shows a web page, provided by the merchant in response to user queries, that allows a user to indicate an intent to purchase an item displayed on the web page. By inputting a click to the “purchase now” feature 902, the user can indicate an intent to purchase the displayed item 904 for the displayed price 906. However, as shown in FIGS. 10A-D, after inputting the intent-to-purchase indication to the web page shown in FIG. 9, a series of additional web pages 1002-1005 are displayed the mobile-phone-using purchaser by the merchant, interaction with which allows the purchaser to log into the merchant's sales site, by supplying a name and password, view purchase details, supply delivery and billing addresses as well as credit-card type, and, finally, provide a credit-card number. The merchant employs the illustrated series of web pages in order to authenticate the user, authenticate the payment method, and authorize the transaction.

Unfortunately, as noted in the previous subsection, because of the relatively low data-transfer rate for user input to mobile devices, and because of the possibility of device disconnection, the multi-web-page interaction illustrated in FIGS. 8-10D may inhibit or prevent a purchaser from completing an e-commerce transaction. Both purchasers and merchants continue to seek more efficient methods for e-commerce carried out from mobile devices.

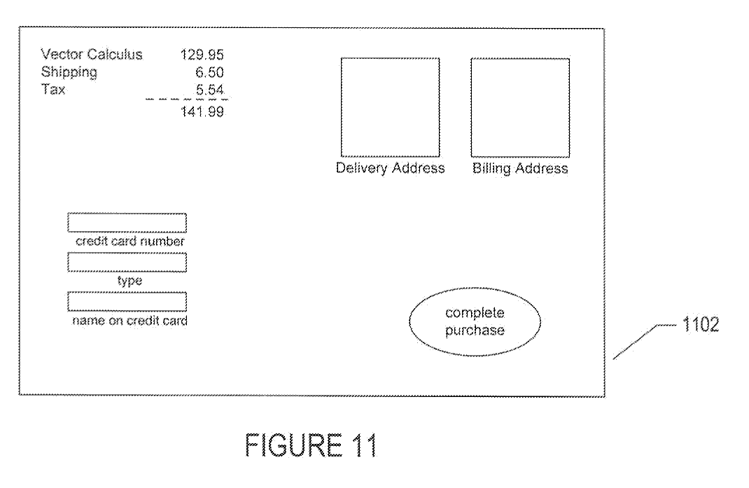

FIG. 11 illustrates one approach to simplifying the e-commerce environment in which mobile-phone users purchase items through e-commerce web pages according to certain embodiments of the present invention. The web page 1102 shown in FIG. 11 essentially combines the four web pages shown in FIGS. 10A-D into a single web page. The web page representing a single-web-page purchase interface, shown in FIG. 11, can be provided when information related to a mobile-phone purchaser, include indentifying information and payment information, can be reliably and securely made available to computers systems involved in transaction processing by methods that do not rely on repeated user input of the needed information. Embodiments of the present invention are directed to acquiring and making available identifying and payment information to transaction-processing systems to enable single-web-page purchasing interfaces, such as the web page shown in FIG. 11, and other streamlined interfaces that minimize the need for user input through constrained mobile-device data-input interfaces.

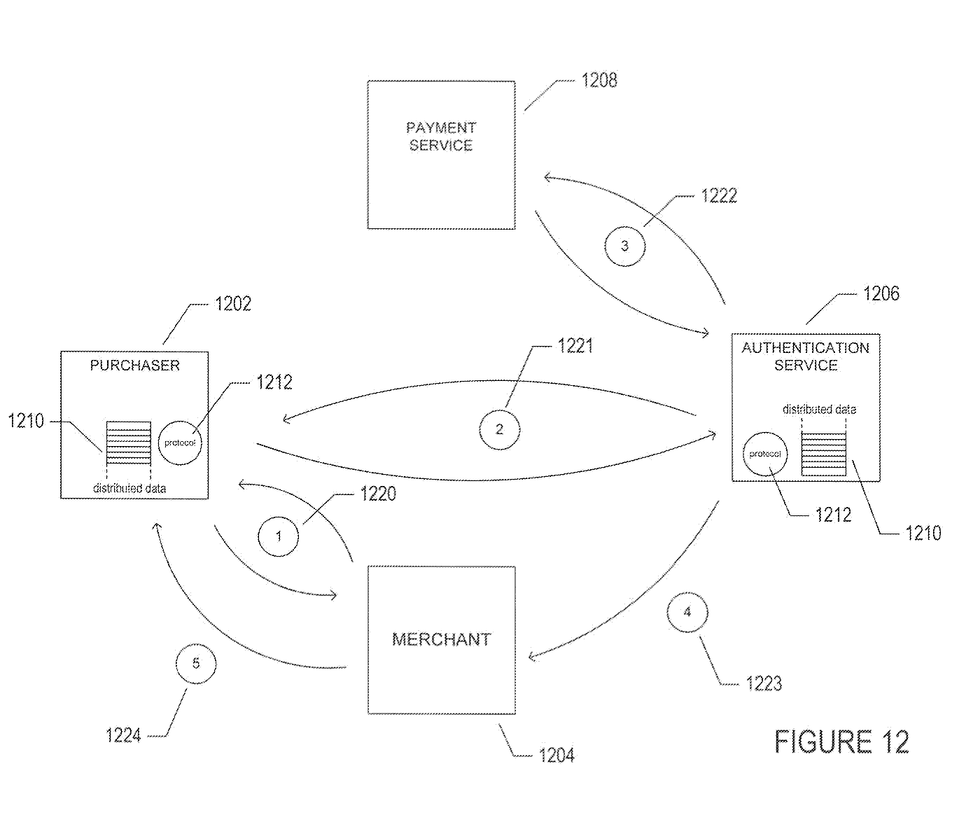

FIG. 12 illustrates an authorization system and protocol that provides identifying and payment information to transaction-processing system in order to streamline e-commerce for mobile-device purchasers, according to one embodiment of the present invention. In FIG. 12, four different devices and systems that participate in an e-commerce transaction are shown. These include a mobile purchaser's device 1202 and a merchant web server 1204, as also shown in FIG. 8, as well as an authentication-service system 1206 and a payment service 1208. In many cases, the merchant, authentication-service, and payment-service systems are geographically separate computer systems that are owned and operated by distinct and separate organizations. However, in certain embodiments of the present invention, the authentication service may be executed on the same computer system that supports one or the merchant or payment service. In certain cases, all three of the authentication service, payment service, and merchant may execute within a single computer system. As shown in FIG. 12, the purchaser device 1202 and authentication service 1206 share distributed data 1210 and an authorization protocol 1212 that carries out purchaser identification and authorization on behalf of the merchant and payment service.

FIG. 12 additionally illustrates an example e-commerce transaction facilitates by the distributed data 1210, protocol 1212, and authentication service according to one embodiment of the present invention. The transaction can be partitioned into 5 stages, shown in FIG. 12 by the 5 circled stage numbers 1220-1224. In the first stage of the transaction, the mobile-phone-using purchaser interacts with web pages served by the merchant system 1204 in order to arrive at a web page, such as that shown in FIG. 9, to which the purchaser can input an indication of a desire to purchase one or more described items and/or services. Upon input of the indication to purchase, either the merchant system invokes an authentication-service-provided authorization protocol or the authentication-service-provided authorization protocol is directly invoked by executable routines associated with the web page or the client-side authorization protocol on the purchaser's mobile device 1202 to launch the second state 1221 of the transaction. During the second stage of the transaction, the authentication service obtains either license information stored as distributed data within the purchaser's device from the purchaser's device or receives user-input and user-device-provided information in order to identify and authorize the transaction. When license information can be obtained from the purchaser's device, the purchaser is relieved from the need to input or re-input the information through a series of interface pages, such as those shown in FIGS. 10A-D. Once the authentication service has obtained sufficient information to prepare a payment request, in the third stage of the transaction 1222, the authentication service transmits the payment request to the payment service 1208, which responds with either an indication of success or failure. Assuming that the payment service has successfully responded, then, in the fourth stage 1223, the payment-service response is forwarded by the authentication service 1206 to the merchant 1204. The merchant completes the transaction, and forwards a completion indication to the purchaser in a fifth stage 1224 of the transaction.

The authentication service, during the e-commerce transactions, deposits and/or updates various types of licenses stored, in part, on the purchaser's device, in order to facilitate subsequent transactions. Different licenses are deposited and/or updated at various stages in the transaction. The different types of licenses are associated with different levels of trust and/or with different types of stored information. Secure communications and/or encryption are employed in order to secure transmission of all confidential information during each of the 5 stages of the e-commerce transaction. For example, a unique license that has an ability to identify and associate specific payment criteria and methods with a device and that can be utilized for future transactions or activity can be stored on the device. The unique license is fabricated utilizing specific, repeatable identifiers of the device along with retrieval of previously collected data. This information can be deposited securely on the device, so that it can reproduce the payment method options that can be performed while participating in an electronic commerce transaction. There are various levels of trusted device licenses to prevent misuse and to detect whether a license has been altered. In addition, the licenses contain information that characterizes the issuing entity. Examples of an entity are hosted computer server systems or point-of-sale devices that have the authority to produce a legitimate license. There may be numerous authorized entities and the information contained in a license to allow an authentication service to correctly certify the authenticity of the license. The license with the lowest level of trust, an initial license token deposited on the device, indicates that a transaction has been performed. The highest-level license is verified by the owner of the device and is approved for future use. When an electronic commerce transaction is initiated on a device, certain licenses or combinations of licenses can be used to reproduce a payment method. A purchaser is given the ability to provide additional information or use the existing data reconstructed from licenses. Upon completion of a transaction, specific details of the transaction are stored on behalf of the purchaser in order to provide historical references and/or to conduct self-serve customer service functions, like cancelling a subscription or purchase, revoking further use of the payment method, or transferring purchases or subscription licenses to another device. The functionality provided by the various licenses not only serves as a means for a device to securely participate in an electronic commerce transaction, but also provides an enhanced user experience featuring reduced data information transmission and easier user data entry, particularly useful for constrained-input devices like mobile phones.

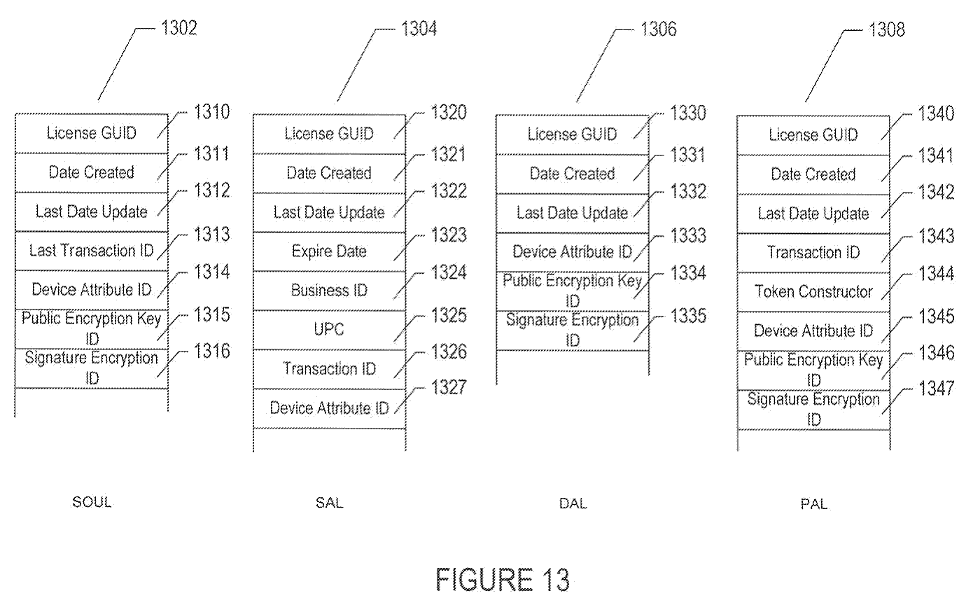

FIG. 13 shows four different types of distributed data structures, or licenses, that may be a shared between a purchaser's device and an authentication service according to one embodiment of the present invention. The four different types of licenses include: single only use license (“SOUL”) 1302; a Sale Authentication License (“SAL”) 1304; a device authentication license (“DAL”) 1306; and a payment authentication license (“PAL”) 1308.

The SOUL is a single-transaction specific license that allows for accessing information related to a particular transaction. The SOUL 1302 includes, in certain embodiments of the present invention, at least the following fields: (1) License GUID 1310, the license's global unique identifier for the attributes stored by the authentication service; (2) Date Created 1311, the date on which the SOUL was created and deposited within a purchaser's device or system; (3) Last Date Updated 1312, the date on which the DAL was last updated on the purchaser's device or system; (4) Last Transaction ID 1313, an identifier of the last purchase transaction purchased by the purchaser; (5) Device Attribute ID 1314, an identifier of a database record that contains information about the number of identifying attributes for the device stored by the authentication service; (6) Public Encryption Key ID 1315, an identifier of a database record that contains information about the encryption key, a public PKI symmetric key that is used for encrypting data structures and information on the purchaser's device or system; and (7) Signature Encryption Key ID 1316, an identifier of a database record that contains information about the encryption key, a public PKI symmetric key that is used for additional encryption of the data structures and information transmitted to the authentication service from the purchaser's device or system. The contents of the entire SOUL data structure, except for the License GUID 403, are encrypted with the encryption key identified by the Public Encryption Key ID 1315 to prevent tampering and to ensure repudiation when stored on the purchaser's device or system. Finally the entire data structure, except for the License GUID 403, is again encrypted with the encryption key identified by the Signature Encryption Key ID 1316 when the data structure is transmitted to the authentication service.

The SAL contains information related to a transaction and can be used, in certain cases, to reconstruct identification and transaction information in order to facilitate subsequent purchases. The SAL 1304 includes, in certain embodiments of the present invention, at least the following fields: (1) License GUID 1320, a global unique identifier for the attributes stored by the authentication service; (2) Date Created 1321, the date on which the SAL was created and deposited within a purchaser's device or system; (3) Last Date Updated 1322, the date on which the SAL was last updated; (4) Expiration Date 1323, the date on which the SAL expires; (5) Business ID 1324, an identifier of a business from which the purchaser purchased an item or service; (6) UPC 1325, an identifier of the product or service purchased by the purchaser; (7) Transaction ID 1326, an identifier of the purchase transaction purchased by the purchaser; and (8) Device Attribute ID 1327, an identifier of the database record that contains information about the number of identifying attributes for the device stored by the authentication service. The SAL is typically be used as means to quickly identify that the device has performed a purchase transaction, somewhat like a “Sales Receipt”. Although the license itself may not contain any useful information if retrieved from an unauthorized system or application, the contents of the entire data structure, except for the License GUID 1330, are encrypted with a pre-assigned encryption key to prevent tampering and to ensure repudiation when the authentication service retrieves and evaluates the license.

The DAL 1306 is a license that represents a relatively high level of trust and that facilitates subsequent transactions. The DAL 1306 includes, in certain embodiments of the present invention, at least the following fields: (1) License GUID 1330, a global unique identifier for the attributes stored by the authentication service; (2) Date Created 1331, the date on which the DAL was created and deposited within a purchaser's device or system; (3) Last Date Updated 1332, the date on which the DAL was last updated on the purchaser's device or system; (4) Device Attribute ID 1333, an identifier of a database record that contains information about the number of identifying attributes for the device stored by the authentication service; (5) Public Encryption Key ID 1334, an identifier of a database record that contains information about the encryption key, a public PKI symmetric key that is used for encrypting data structures and information on the purchaser's device or system; and (6) Signature Encryption Key ID 1335, an identifier of a database record that contains information about the encryption key, a public PKI symmetric key, that is used for additional encryption of the data structures and information transmitted to the authentication service from the purchaser's device or system. The contents of the entire data structure, except for the License GUID 1330, are encrypted with the encryption key identified by the Public Encryption Key ID 1334 to prevent tampering and to ensure repudiation when stored on the purchaser's device or system. Finally the entire data structure, except for the License GUID 1330, is once again encrypted with the encryption key identified by the Signature Encryption Key ID 1335 when the Data Structure is transmitted to the authentication service.

The PAL 1308 contains information about a payment method and is used to facilitate subsequent transactions. The PAL 308 includes, in certain embodiments of the present invention, at least the following fields: (1) License GUID 1340, a global unique identifier for the attributes stored by the authentication service; (2) Date Created 1341, the date on which the DAL was created and deposited within a purchaser's device or system; (3) Last Date Updated 1342, the date on which the DAL was last updated on the purchaser's device or system; (4) Transaction ID 1343, an identifier of a purchase transaction; (5) Token Constructor 1344, a random sequence of the payment method's unique identifier that is used to reconstruct a full sequence of the payment method identifier; (6) Device Attribute ID 1345, an identifier of the database record that contains information about the number of identifying attributes for the device stored by the authentication service; (7) Public Encryption Key ID 1346, an identifier of the database record that contains information about the encryption key, a public PKI symmetric key that is used for encrypting data structures and information on the purchaser's device or system; and (8) Signature Encryption Key ID 1347, an identifier of the database record that contains information about the encryption key, a public PKI symmetric key that is used for additional encryption of the data structures and information transmitted to the authentication service from the purchaser's device or system. The contents of the entire data structure, except for the License GUID 1340, are encrypted with the encryption key identified by the Public Encryption Key ID 1346 to prevent tampering and to ensure repudiation when stored on the purchaser's device or system. Finally the entire data structure, except for the License GUID 1340, is once again encrypted with the encryption key identified by the Signature Encryption Key ID 1347 when the data structure is transmitted to the authentication service.

Each of the authentication licenses may contain additional fields. For example, the DAL may contain, or contain references to, one or more PALs. The attributes that identify the device and/or user may include: (1) a browser version; (2) client time zone; (3) client IP address; (4) device type; (5) host name; (6) user name; (7) processor type; (8) memory space; (9) SIM card identifier; (10) OS version; and (11) language displayed by the device. Additional attributes may be employed.

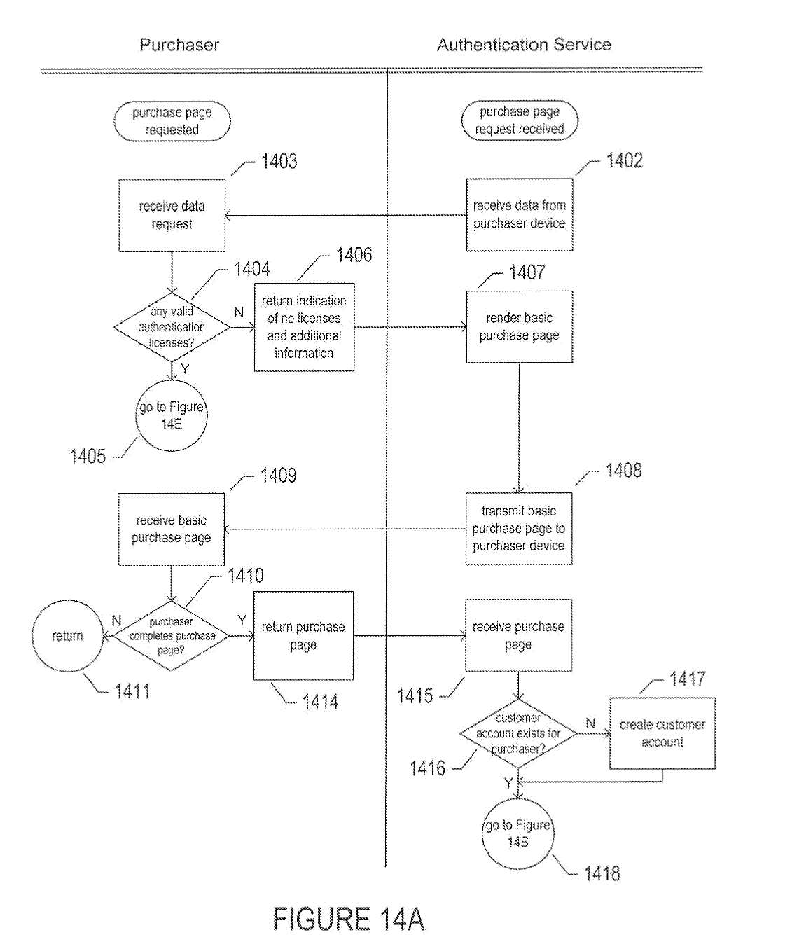

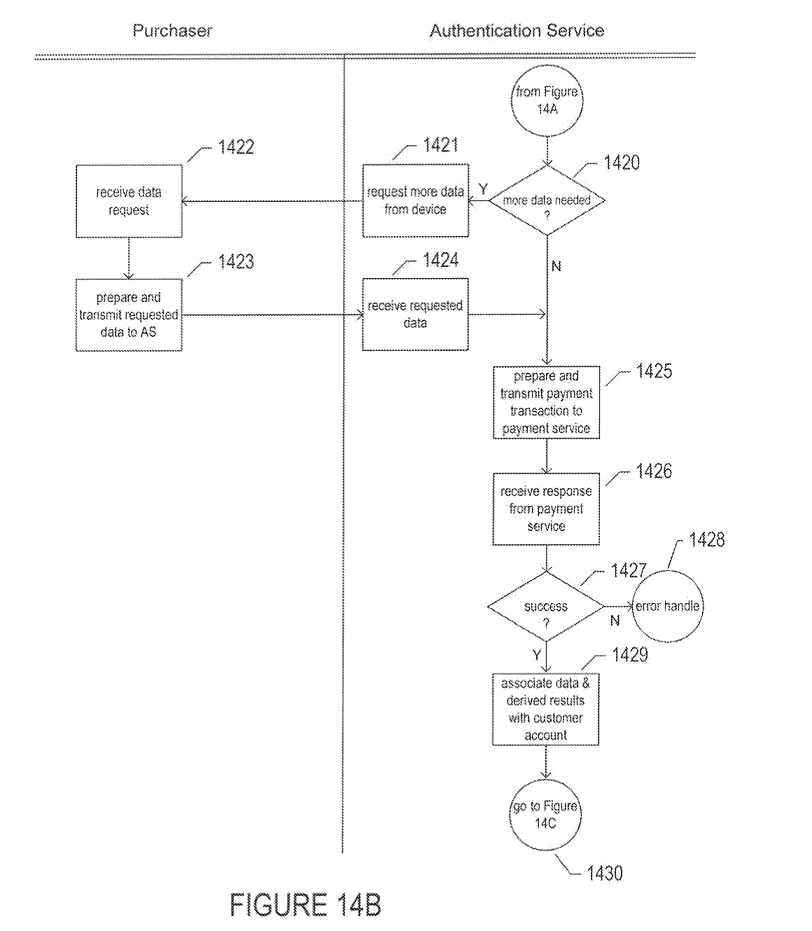

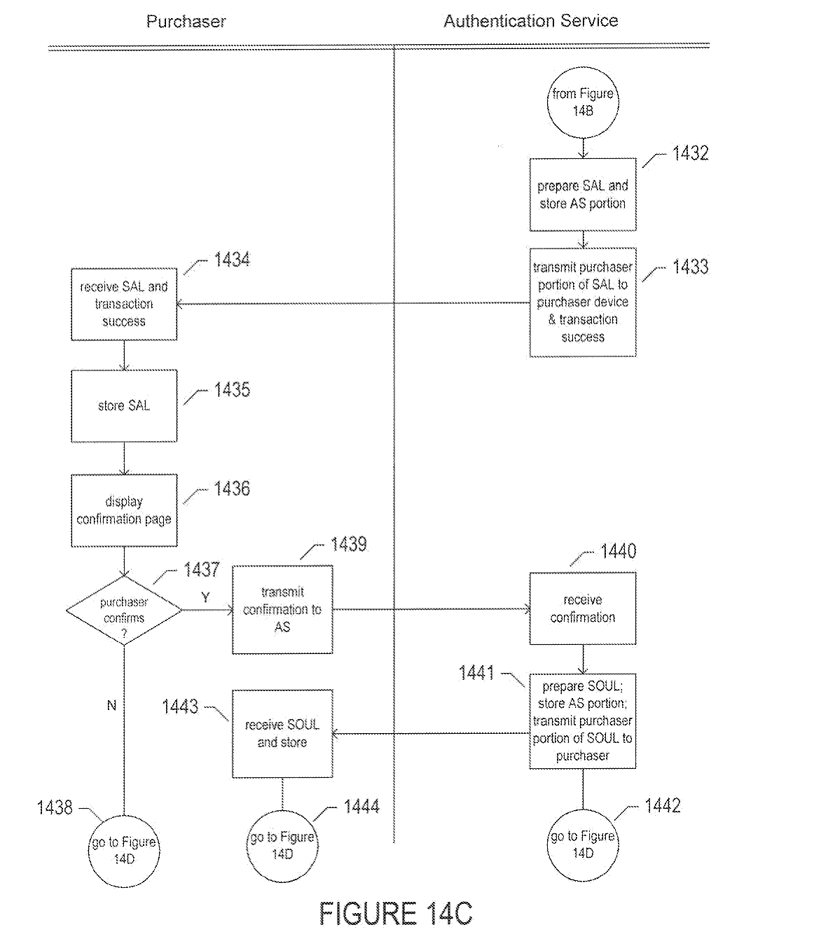

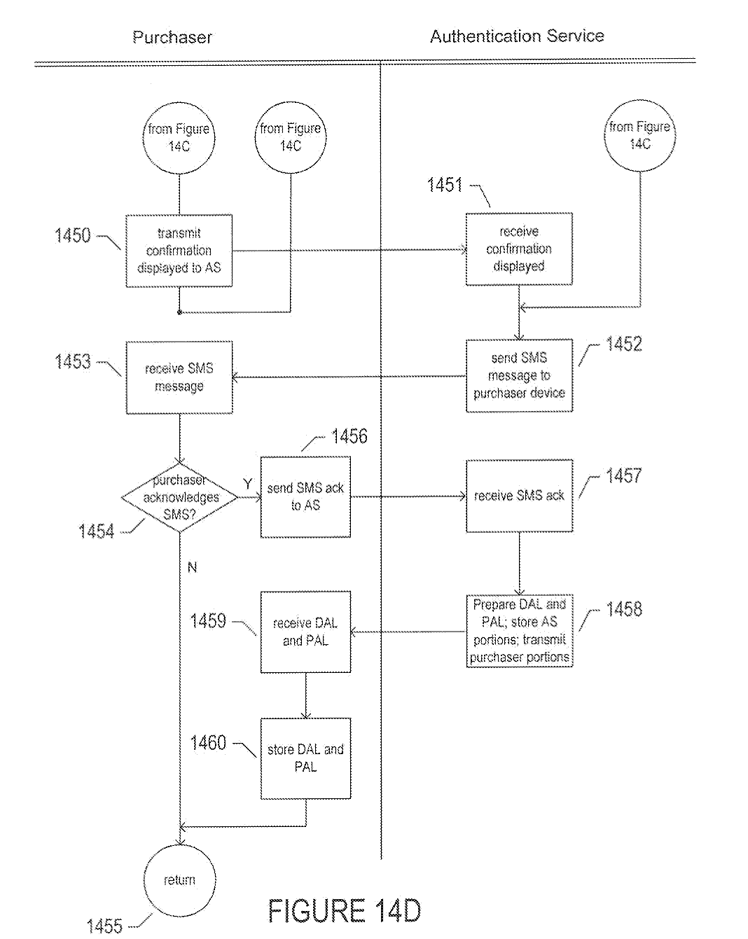

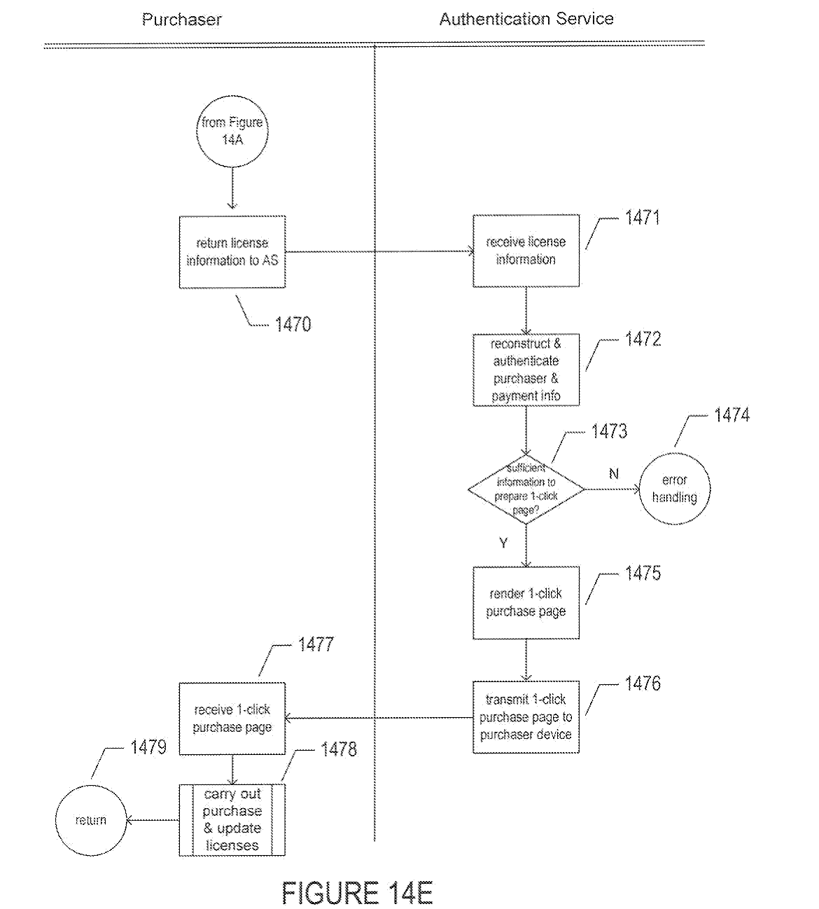

FIGS. 14A-E illustrate, in control-flow-like diagrams, an authentication-service protocol that represents one embodiment of the present invention. Each figure of FIGS. 14A-E is divided vertically into a left-hand purchaser side and a right-hand authentication-service side to illustrate steps that occur on a purchaser's device and within the authentication service, respectively. The protocol begins, in FIG. 14A, when a purchaser has input an intention to purchase one or more items or services to a web page, such as that shown in FIG. 9. The authentication service then undertakes identification of the purchaser and the purchaser's device and authorization of the intended transaction: When sufficient licenses are discovered by the authentication service on the purchaser's device, the authentication service can prepare, on behalf of the merchant system, a streamlined transaction page, such as that shown in FIG. 11, that allows a purchaser to complete the transaction with no or minimal additional information input. When sufficient licenses are not discovered by the authentication service on the purchaser's device, the authentication service collects the needed information to identify the purchaser and the purchaser's device and to authorize the intended transaction, and deposits one or more licenses on the purchaser's device to provide access to information about the transaction to the purchaser as well as to facilitate subsequent transactions.

Referring to FIG. 14A, when the authentication-service protocol is invoked by the purchaser's input to indicate a desire to purchase one or more items and/or services, the authentication service, in step 1402, requests various identifying data from the purchaser's device corresponding to several or more of the above mentioned attributes as well as information to identify any unexpired licenses stored within the purchaser's device. In step 1403, the purchaser's device receives the data request. If there are valid license on the purchaser's device, identification and authentication can be short circuited, as discussed above, and the protocol continues in FIG. 14E, as indicated by step 1405. When no licenses or insufficient licenses reside on the purchaser's device, then, in step 1406, the purchaser's device returns an indication of insufficient licenses and the requested attribute values. In many embodiments of the present invention, the information request and submission may involve two or more message exchanges rather than the single exchange shown in FIG. 14A. In step 1407, the authentication service prepares a basic purchase page, such as the page shown in FIG. 11, with all or many blank fields that need input by the purchaser in order to complete the transaction. This represents an undesired, non-streamlined transaction interface that can be subsequently avoided when adequate licenses are present in the purchaser's device. In step 1408, the authentication service transmits the basic purchase page to the purchaser's device. In step 1409, the purchaser's device receives the basic purchase page and displays the page to the purchaser. When the purchaser fails to complete the page and return it to the authentication service via user input, then the protocol terminates, in step 1411. Various intermediate user actions, such as incomplete completion of the basic purchase page, are not shown in FIG. 14A in the interest of brevity. Such cases can be handled by redisplay of the page or additional interface operations. When the purchaser completes the basic purchase page, as determined in step 1410, the completed purchase page is returned to the authentication service, in step 1414. As a note, by “returning a page,” the current discussion intends to convey that information requested of the purchaser is collected, packaged, and returned to the authentication service by a suitable communications method. Furthermore, the various exchanges of information are generally via IP communications. Exceptions are noted, below. In step 1415, the authentication service receives the information requested via the basic purchase page. When a customer account does not already exist for the purchaser, as detected in step 1416, a customer account is created within the authentication system, in step 1417, and collected information is associated with that account.

Referring to FIG. 14B, the authentication service, in the case more information is needed from the purchaser's device, undertake another information request exchange in steps 1420-1424. Next, in step 1425, the authentication service prepares and transmits a payment-transfer request to an appropriate payment service and receives the payment-service's response, in steps 1425-1426. The appropriate payment service may, for example, be an electronic credit-card transaction service provided by a financial organization that issued a credit card used by the purchaser for the transaction. When, as determined in step 1427, the payment service refuses payment, error handling is invoked in step 1428. This may involve again requesting payment from the payment service, requesting a different form of payment from the purchaser and attempting to obtain payment authorization from a different payment service, or any of various other error-handling strategies. When payment is authorized, then, in step 1429, the authentication service associates various data and derived results with the customer account for the purchaser, and the protocol description continues in FIG. 14C, as indicated by step 1430.

Referring to FIG. 14C, the authentication service next prepares a SAL for the transaction and stores the authentication-service (“AS”) portion of the SAL within the AS system. In step 1433, the authentication service transmits the purchaser's device portion of the SAL to the purchaser's device. In step 1434, the purchaser's device receives the SAL and an indication of transaction success. In step 1435, the SAL is stored within a memory the purchaser's device. In step 1436, the purchaser's device displays a confirmation page to the purchaser through a display interface. When the purchaser confirms the transaction via the display interface is response to display of the confirmation page, as determined in step 1437, a confirmation indication is transmitted to the authentication service in step 1439. Otherwise, steps illustrated in FIG. 14D are taken, as indicated by step 1438. In step 1440, the authentication service receives the confirmation indication and, in step 1441, prepares a SOUL, stores the AS portion of the SOUL in AS system memory or on AS system mass-storage devices, and transmits the purchaser's device portion of the SOUL to the purchaser's device. Authentication-service operation continues in FIG. 14D, as indicated by step 1442. In step 1443, the purchaser's device receives the SOUL and stores the SOUL within the purchaser's device. The purchaser's device carries out additional steps, shown in FIG. 14D, as indicated by step 1444.

Referring to FIG. 14D, when the purchaser fails to confirm the transaction, then, in step 1450, the purchaser's device transmits an indication to the authentication service that the confirmation page was displayed to the purchaser, received by the authentication service in step 1451. In step 1452, the authentication service sends a small-message service (“SMS”) through the telephone network, or some other non-IP message, to the purchaser's device to request acknowledgment from the purchaser. The SMS message is received, in step 1453, by the purchaser's device and an acknowledgement request is displayed to the purchaser through a display interface. When the purchaser fails to acknowledge the transaction, as determined in step 1454, the protocol terminates in step 1455. Otherwise, the acknowledgement is transmitted by the purchaser's device, in step 1456, to the authentication service, which receives the acknowledgement in step 1457. In step 1458, the authentication service prepares a DAL and a PAL for the transaction, stores AS portions of the DAL and PAL within the AS system, and transmits the purchaser's device portions of the DAL and PAL to the purchaser's device. In step 1459, the purchaser's device receives the DAL and PAL and stores the DAL and PAL in the purchaser's device, in step 1460. Of course, information is stored in the purchaser's device within one or more electronic memories. Note that the DAL and PAL represent a high level of trust, since the purchaser has confirmed a transaction associated with the PAL and DAL multiple times by at least two different communications methods.

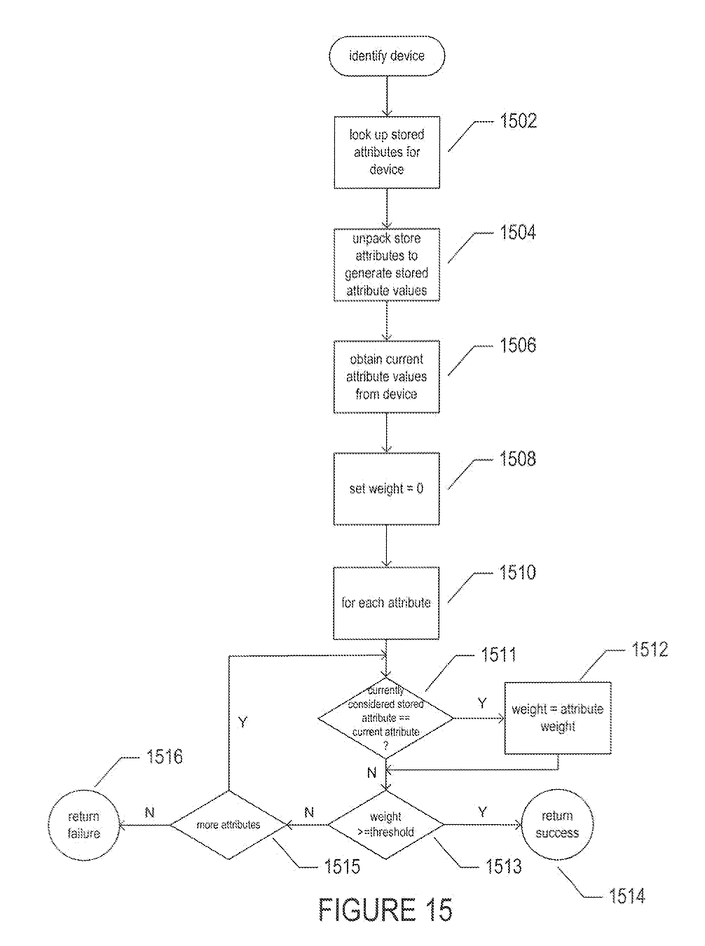

Referring to FIG. 14E, which continues the branch of the authentication-system protocol represented by step 1405 in FIG. 14A, where licenses are discovered by the authentication service on the purchaser's device, indications of the licenses and requested information are returned, in step 1470, by the purchaser's device to the authentication service. In step 1471, the license information is received by the authentication service. In step 1472, the authentication service attempts to reconstruct information needed to seek payment authorization from the license information and to identify the purchaser. When sufficient information cannot be reconstructed, as determined in step 1473, then error handling is invoked in step 1474. The error handling may involve further attempts to acquire the needed information or, if such attempts fail, preparation of a base purchase page with blank fields indicating needed information and undertaking of the above-described portion of the AS protocol to obtain the needed information. Note that attribute values for the device obtained earlier in the AS protocol are compared to stored attribute values for the purchaser's device, in step 1472, to identify the purchaser's device. This process is further described below, with reference to FIG. 15. The stored attributes are accessed using Device Attribute ID fields of licenses or information associated with a customer account. When sufficient information is reconstructed, as determined in step 1473, then a streamlined purchase page is prepared, in step 1475, by the authentication service and transmitted, in step 1476, to the purchaser's device. In step 1477, the purchaser's device receives the streamlined purchase page and the purchase transaction can be completed, by the purchaser, in step 1478, generally by submitting a single click or input indication via a display interface. The streamline purchase page may be a page, such as that shown in FIG. 11, with all information fields filled in. Thus, a user can accept the information as is, and complete the purchase, or alter the information and return the altered information to the authentication service, for authentication and storage. The authentication service also deposits or updates licenses to reflect the transaction completion on the purchaser's device.

FIG. 15 provides a control-flow diagram for a device-identification routine used by the authentication service to identify and authenticate a purchaser's device, according to one embodiment of the present invention. The authentication service uses a Device Attribute ID to retrieve stored attributes for the device from an AS-system database, in step 1502. When necessary, attribute values are unpacked from stored information in step 1504. In step 1506, current attribute values are obtained, by a protocol message exchange, from the purchaser's device. In step 1508, the variable “weight” is set to the value “0.” Then, in the for-loop of steps 1510-1516, all of the attributes relevant to the purchaser's device are considered, one per iteration of the for-loop. When the currently-considered device attribute has a current value equal to the corresponding stored value, as determined in step 1511, then the variable “weight” is incremented by a weight for the currently-considered attribute. Should the value stored in the variable “weight” exceed a threshold value, as determined in step 1513, then the purchaser's device is deemed to have been successfully identified, in step 1514. When all attributes are considered, but the value stored in the variable “weight” does not equal or exceed the threshold value, then failure is returned, in step 1516. Thus, device attributes can change, by a certain amount, over time, without requiring a full re-authentication of the device, provided that a sufficient number of attributes, or a sufficient number of highly weighted attributes, remain in correspondence with corresponding values stored for the device within the AS system.

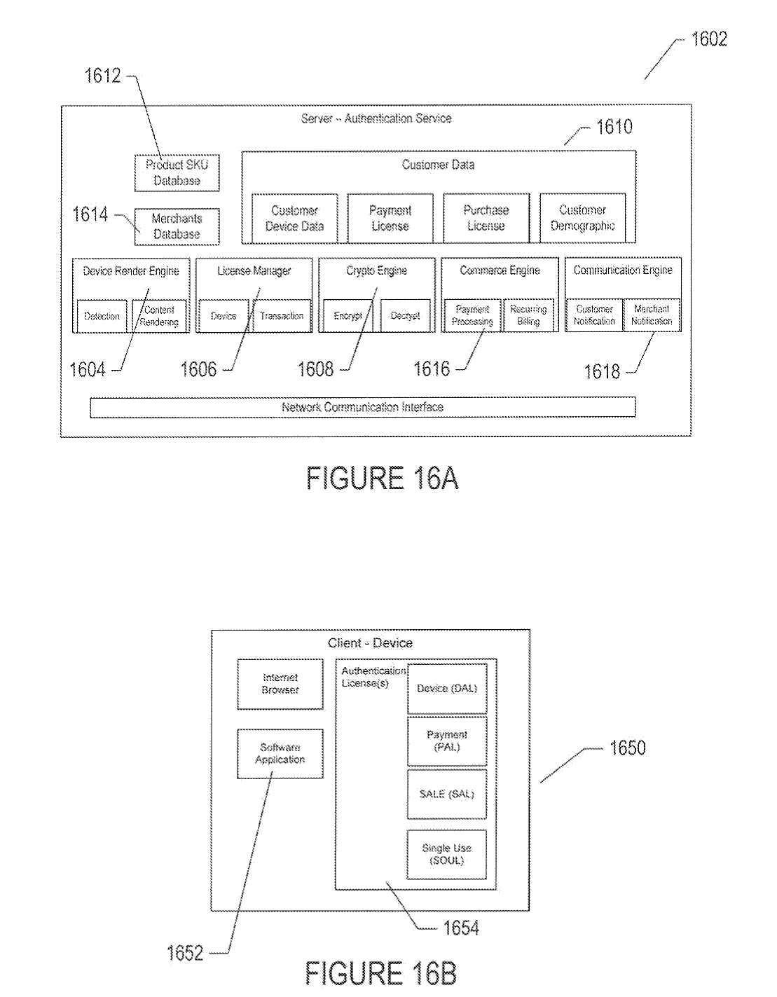

The authentication service is a server system that is implemented according to a client/server architecture. FIGS. 16A-B illustrate an authentication-service architecture and corresponding client-side architecture for devices that are authenticated by the authentication service, according to one embodiment of the present invention. The authentication service performs various functions, retains authentication licenses and information associated with a purchasers' devices and payment methods.

FIG. 16A shows an architecture diagram for the authentication service 1602. When a purchaser's device initiates a request to conduct a commerce transaction, information retrieved from the device is directed to the Device Render Engine (“DRE”) 1604 subcomponent within the authentication service. DRE is responsible for detecting a purchaser's device capabilities and features and for communicating with the License Manager (“LM”) subcomponent 1606 to evaluate any authentication licenses provided to the authentication service. The Crypto Engine (“CE”) subcomponent 1608 is invoked to decrypt received licenses and other encrypted information. Customer accounts and data are stored within a Customer Data (“CD”) subcomponent 1610. Information for items and services purchased through transactions is stored in a Product SKU Database (“PSKUD”) subcomponent 1612 merchant data is stored in a Merchant Database (“MD”) subcomponent 1614. A Commerce Engine (“CME”) component processes commerce transactions 1616. The CME acts as a gateway between the authentication service and the purchaser's device or system. It communicates with a variety of payment services via TCP/IP/HTTPS/SSL connections to ensure secure transmissions of the information. A Communications Engine (“CCE”) 1618 subcomponent handles communication between the authentication service and mobile devices, merchant systems, and payment-service systems. The entire transaction process is a real-time, synchronous transaction. The information exchanged to carry out a transaction is transmitted through secure network transmission, immediately processed, and the pertinent information returned to authentication service.

FIG. 16B shows an architectural diagram 1650 for client-side authentication-service functionality stored on a purchaser's device. The client-side architecture includes routines that implement the device portion of above-described authentication-service protocol 1652 and various stored authentication licenses 1654 described above.

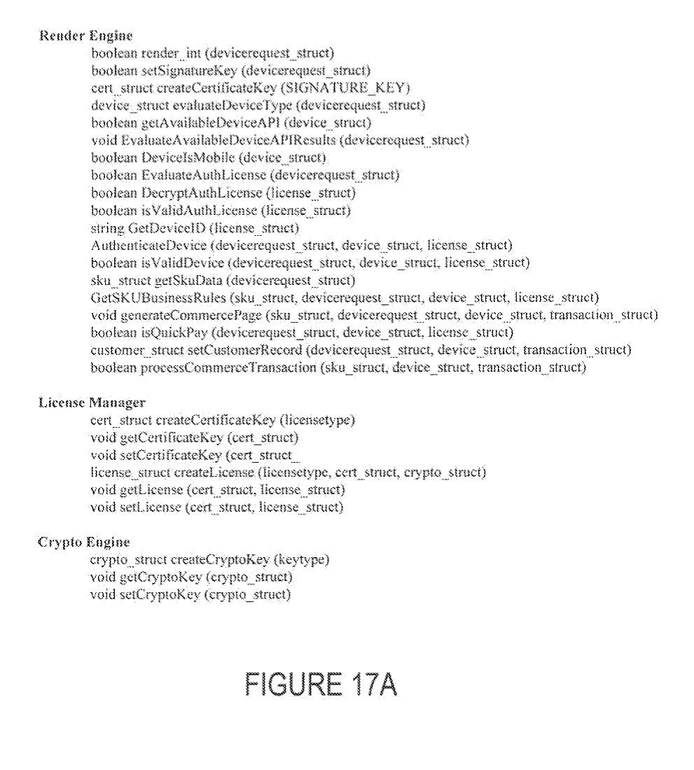

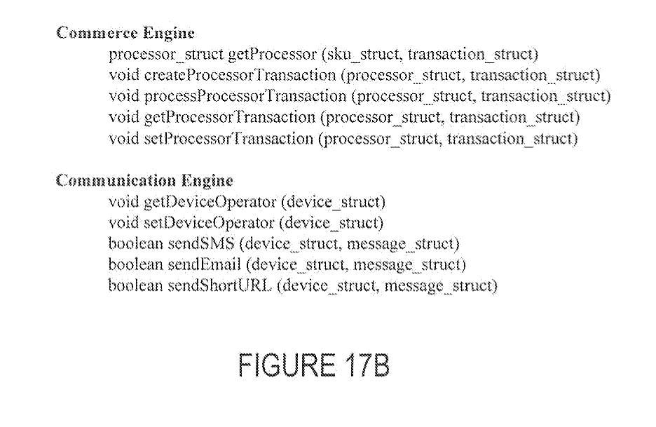

FIGS. 17A-B provide a representative example of routines included in each of the subcomponents of an authentication service that represents one embodiment of the present invention. Proceeding in the order of routines listed in FIGS. 17A-B, descriptions of the routines are next provided.

For the DRE, the render_int routine initializes the subroutines/code functions and variables that are retrieved from the client device. Device information is stored in structured data elements that are used during the client connection session to the server. The setSignatureKey routine retrieves and sets a crypto key that is used on the data payload that is transmitted between the client and server. The createCertificateKey routine creates and sets a certificate key used on a device to identify the client device. The evaluateDeviceType routine determines a device from a set of variables that have retrieved based on known identifiers from device manufactures. The getAvailableDeviceAPI routine determines available device features and open-api functions that can be performed on the device. The EvaluateAvailableDeviceAPIResults routine executes specific api functions on a device to determine validity of the device. The DevicelsMobile routine determines device type as mobile, pc, or other. The EvaluateAuthLicense routine retrieves authentication licenses from a device. The DecryptAuthLicense routine decrypts an authentication license. The is ValidAuthLicense routine determines whether an authentication license is valid. The GetDeviceID routine retrieves a previously set Device Identifier within an authentication license. The AuthenticateDevice routine performs a comparison of an authentication license and device attributes that were retrieved from a device. The is ValidDevice routine determines whether or not a device is authenticated. The getSkuData routine retrieves product information used for the purchase. The GetSKUBusinessRules routine retrieves a specific rule that is associated with a product and a purchase. The generateCommercePage routine initiates and structures the rendering of a purchase page. The is QuickPay routine determines whether or not a purchase page has enough information to reduce the user's input on the purchase page. The setCustomerRecord routine sets customer's information retrieved from a purchase session. The processCommerceTransaction routine commits a purchase to the payment processor.

For the LM, the createCertificateKey routine sets and assigns certificate keys. The getCertificateKey routine retrieves certificate keys. The setCertificateKey routine assigns certificate keys. The createLicense routine creates specific authentication license used on a device. The getLicense routine retrieves a certificate key license from a database for an authentication license. The setLicense routine sets a certificate key that creates an authentication license.

For the CE, the createCryptoKey routine creates encryption keys that are used for encrypting. The getCryptoKey routine retrieves encryption keys that have been set. The setCryptoKey routine assigns encryption keys.

For the CME, the getProcessor routine determines an appropriate payment service to be used for a transaction. The createProcessorTransaction routine creates a payment transaction that is submitted to the payment processor. The processProcessorTransaction routine submits a payment transaction to a payment service. The getProcessorTransaction routine evaluates a payment transaction. The setProcessor Transaction routine sets payment transaction information.

For the CCE, the getDeviceOperator routine determines a mobile device operator network. The setDeviceOperator routine sets mobile device operator information used to perform SMS and network communication. The sendSMS routine sends/transmits an SMS text message to a device. The sendEmail routine sends e-mail communication to an Internet e-mail address. The sendShortURL routine sends/transmits an SMS text message with a structured message.

Although the present invention has been described in terms of particular embodiments, it is not intended that the invention be limited to these embodiments. Modifications will be apparent to those skilled in the art. For example, an authentication service and authentication protocol can be implemented in various ways by varying any of many implementation parameters, including programming language, operating system platform, control structures, data structures, modular organization, and other such implementation parameters. Although four types of authentication license are discussed above, a greater number or fewer number of authentication-license types may be employed in alternative implementations of an authentication service and authentication-service protocol.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An authentication system comprising:
a computer system; and
an authentication service executed by the computer system that receives authentication requests from a purchaser's mobile device, authenticates the purchaser's mobile device and purchaser, submits payment requests to payment services on behalf of the purchaser, and that creates and maintains at least two types of distributed-data-structure authentication license shared between the purchaser's mobile device and the authentication system to facilitate subsequent authentication requests from the purchaser by providing information needed for authentication that would otherwise need to be supplied by the purchaser.

2. The authentication system of claim 1 wherein the authentication service creates a single-only-use authentication license, referred to as a “SOUL.”

3. The authentication system of claim 2 wherein the SOUL is a single-transaction specific license that allows for accessing information related to a particular transaction and wherein the SOUL includes:
a License GUID field that stores a global unique identifier for attributes stored by the authentication service;
a Date Created field that stores a date on which the SOUL was created and deposited within the purchaser's mobile device;
a Last Date Updated field that stores a date on which the DAL was last updated on the purchaser's mobile device;
a Last Transaction ID field that stores an identifier of the last purchase transaction purchased by the purchaser;
a Device Attribute ID field that stores an identifier of a database record that contains information about the number of identifying attributes for the purchaser's mobile device stored by the authentication service;
a Public Encryption Key ID field that stores an identifier of a database record that contains information about the encryption key, a public PKI symmetric key that is used for encrypting data structures and information on the purchaser's mobile device; and
a Signature Encryption Key ID field that stores an identifier of a database record that contains information about the encryption key, a public PKI symmetric key that is used for additional encryption of the data structures and information transmitted to the authentication service from the purchaser's mobile device.

4. The authentication system of claim 1 wherein the authentication service creates a sale authentication license, referred to as a “SAL.”

5. The authentication system of claim 4 wherein the SAL contains information related to a transaction that can be used to reconstruct identification and transaction information and wherein the SAL includes:
a License GUID that stores a global unique identifier for the attributes stored by the authentication service;
a Date Created that stores a date on which the SAL was created and deposited within a purchaser's mobile device;
a Last Date Updated that stores a date on which the SAL was last updated; a Expiration Date that stores a date on which the SAL expires;
a Business ID that stores an identifier of a business from which the purchaser purchased an item or service;
a UPC that stores an identifier of the product or service purchased by the purchaser; a Transaction ID that stores an identifier of the purchase transaction purchased by the purchaser; and
a Device Attribute ID that stores an identifier of the database record that contains information about the number of identifying attributes for the purchaser's mobile device stored by the authentication service.

6. The authentication system of claim 1 wherein the authentication service creates a device authentication license, referred to as a “DAL.”

7. The authentication system of claim 6 wherein the DAL is a license that represents a relatively high level of trust and that facilitates subsequent authentications and wherein the DAL includes:
a License GUID that stores a global unique identifier for the attributes stored by the authentication service;
a Date Created that stores a date on which the DAL was created and deposited within a purchaser's mobile device;
a Last Date Updated that stores a date on which the DAL was last updated on the purchaser's mobile device;
a Device Attribute ID that stores an identifier of a database record that contains information about the number of identifying attributes for the purchaser's mobile device stored by the authentication service;
a Public Encryption Key ID that stores an identifier of a database record that contains information about the encryption key, a public PKI symmetric key that is used for encrypting data structures and information on the purchaser's mobile device; and
a Signature Encryption Key ID that stores an identifier of a database record that contains information about the encryption key, a public PKI symmetric key, that is used for additional encryption of the data structures and information transmitted to the authentication service from the purchaser's mobile device.

8. The authentication system of claim 1 wherein the authentication service creates a payment authentication license, referred to as a “PAL.”

9. The authentication system of claim 8 wherein the PAL contains information about a payment method and is used to facilitate subsequent authentications and wherein the PAL includes:
a License GUID that stores a global unique identifier for the attributes stored by the authentication service;
a Date Created that stores a date on which the DAL was created and deposited within a purchaser's mobile device;
a Last Date Updated that stores a date on which the DAL was last updated on the purchaser's mobile device;
a Transaction ID that stores an identifier of a purchase transaction;
a Token Constructor that stores a random sequence of the payment method's unique identifier that is used to reconstruct a full sequence of the payment method identifier;
a Device Attribute ID that stores an identifier of the database record that contains information about the number of identifying attributes for the purchaser's mobile device stored by the authentication service;
a Public Encryption Key ID that stores an identifier of the database record that contains information about the encryption key, a public PKI symmetric key that is used for encrypting data structures and information on the purchaser's mobile device; and
a Signature Encryption Key ID that stores an identifier of the database record that contains information about the encryption key, a public PKI symmetric key that is used for additional encryption of the data structures and information transmitted to the authentication service from the purchaser's mobile device.

10. The authentication system of claim 1 wherein the authentication service receives an authentication request from the purchaser's mobile device when the purchaser inputs an indication of an intent to purchase to a commerce web page served by a merchant system.

11. The authentication system of claim 1 wherein the authentication service receives an authentication request from a merchant system when the purchaser inputs an indication of an intent to purchase to a commerce web page served by the merchant system.

12. The authentication system of claim 1 wherein the authentication service requests attribute values that characterize the purchaser's mobile device and, upon receiving the attribute values, compares the received attribute values to stored attribute values in order to authenticate the purchaser's mobile device.

13. The authentication system of claim 12 wherein the authentication service, for each attribute, compares the received attribute value to a corresponding stored attribute value and, when the received attribute value is equal to the stored attribute value, increments a variable by a weight corresponding to the attribute and, when the incremented variable is greater than or equal to a threshold value, returns an indication of success.

14. The authentication system of claim 13 wherein the attributes include one or more of:
a browser version;
a time zone;
an IP address;
a device type;
a host name;
a user name;
a processor type;
a memory space;
a SIM card identifier;
an OS version; and
a language displayed by the purchaser's mobile device

15. The authentication system of claim 1 wherein, when the authentication service can authenticate the purchaser and the purchaser's mobile device from authentication licenses shared between the purchaser's mobile device and the authentication system and from attribute values retrieved from the purchaser's mobile device, and when the authentication service can reconstruct sufficient information to prepare a payment request, the authentication prepares and transmits to the purchaser's device a streamlined purchase page to the purchaser's mobile device that allows the purchaser to complete a purchase transaction with minimal additional input to the purchaser's mobile device.

16. The authentication system of claim 1 wherein, when the authentication service cannot authenticate the purchaser and the purchaser's mobile device from authentication licenses shared between the purchaser's mobile device and the authentication system and from attribute values retrieved from the purchaser's mobile device, or when the authentication service cannot reconstruct sufficient information to prepare a payment request, the authentication prepares and transmits to the purchaser's device a basic purchase page to the purchaser's mobile device that allows the purchaser to complete a purchase transaction by supplying needed information through an interface provided by the purchaser's mobile device.

17. The authentication system of claim 1 wherein the authentication service, upon successfully authenticating a purchaser and purchaser's mobile device and receiving authorization for payment from a payment service, creates a single-user-only authentication license and a sale authentication license distributed between the authentication service and the purchaser's mobile device.

18. The authentication system of claim 1 wherein the authentication service, upon successfully authenticating a purchaser and purchaser's mobile device and receiving authorization for payment from a payment service, and upon receiving confirmation from the purchaser through a non-IP communications medium, creates a device authentication license and a payment authentication license distributed between the authentication service and the purchaser's mobile device.
